(19) United States
(12) Patent Application Publication
(10) Pub. No.: US 2010/0164392 A1
(43) Pub. Date: Jul. 1, 2010

(54) DISCHARGE LAMP LIGHTING APPARATUS

(75) Inventor: Toru Ashikaga, Saitama (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SANKEN ELECTRIC CO., LTD., SAITAMA (JP)

(21) Appl. No.: 12/665,057

(22) PCT Filed: Aug. 8, 2008
(86) PCT No.: PCT/JP08/64332

§ 371 Date: Dec. 17, 2009

(30) Foreign Application Priority Data
Aug. 27, 2007 (JP) 2007-220071

(51) Int. Cl. H05B 41/26

(52) U.S. Cl. 315/246

(57) ABSTRACT

A discharge lamp lighting apparatus is inexpensive and is capable of generally relaxing an unevenness of brightness caused by a brightness gradient of a discharge lamp. The apparatus includes an inverter 10a to receive a DC voltage, convert the DC voltage into an alternating voltage, and output the alternating voltage from a first output terminal and second output terminal, a first ballast element C11 whose first terminal is connected to the first output terminal of the inverter, a first discharge lamp 1a connected between a second terminal of the first ballast element and the second output terminal of the inverter, a second ballast element C21 whose first terminal is connected to the second output terminal of the inverter, and a second discharge lamp 2a connected between a second terminal of the second ballast element and the first output terminal of the inverter.

### TECHNICAL FIELD

The present invention relates to a discharge lamp lighting apparatus to light a plurality of discharge lamps such as CCFLs (Cold Cathode Fluorescent Lamps), external electrode fluorescent lamps, and fluorescent lamps, and particularly, to a technique of correcting brightness gradients of discharge lamps.

### BACKGROUND TECHNOLOGY

Generally, a cold cathode fluorescent lamp is lighted by an inverter that applies a voltage of several hundreds to one thousand several hundreds of volts at a frequency of several tens of kilohertz to the lamp. There is a fluorescent lamp called an external electrode fluorescent lamp (EEFL). The external electrode fluorescent lamp and cold cathode fluorescent lamp have different electrode structures, but the remaining parts including light emission principles of the lamps are substantially the same. Accordingly, inverters for lighting the external electrode fluorescent lamp and cold cathode fluorescent lamp are the same in principle. Because of this, the following explanation is made in connection with the cold cathode fluorescent lamp (referred to as “discharge lamp”).

FIG. 1 is a view illustrating the configuration of such an inverter. The inverter 10 has an alternating voltage generation circuit 11 and a voltage conversion circuit 12.

The alternating voltage generation circuit 11 switches a DC voltage from a DC power source Vin at a predetermined frequency and generates an alternating voltage. The voltage conversion circuit 12 converts the alternating voltage from the alternating voltage generation circuit 11 into a required alternating voltage and outputs the same from a first output terminal and second output terminal.

A discharge lamp has a negative resistance characteristic, and therefore, an element having a positive resistance characteristic, such as a capacitor and an inductance is connected in series with the discharge lamp so that a synthetic impedance may have a positive resistance characteristic. A capacitor connected for this purpose is called a ballast capacitor and a coil connected for the same purpose is called a ballast coil. FIG. 2 is a view illustrating the configuration of a related discharge lamp lighting apparatus that connects discharge lamps 1 to an inverter 10 through ballast capacitors C1 to C4. FIG. 3 is a view illustrating a configuration example of a related discharge lamp lighting apparatus that connects a discharge lamp 1 to an inverter 10 through a ballast coil L.

As the discharge lamp has elongate shape, it needs higher voltage, and therefore, the inverter must generate higher voltage. Then, the inverter must employ parts having higher withstand voltage. This increases the cost of the inverter. To solve the problem, there has been developed a discharge lamp lighting apparatus illustrated in FIG. 4 employing an inverter 10a that uses parts having low withstand voltage.

According to this discharge lamp lighting apparatus, the inverter 10a has a voltage conversion circuit 12a composed of a transformer Ta. At a midpoint of a secondary winding of the transformer Ta, a center tap is arranged to divide the secondary winding into a secondary winding S1 and secondary winding S2. The center tap is connected to the ground (for example, a casing), an end (non-grounded terminal) of the secondary winding S1 is connected to a first output terminal, the first output terminal is connected through ballast capacitors C1 to C4 to first ends of discharge lamps 1a to 1d, an end (non-grounded terminal) of the secondary winding S2 is connected to a second output terminal, and the second output terminal is connected through ballast capacitors C5 to C8 to second ends of the discharge lamps 1a to 1d.

With this configuration, the transformer Ta outputs an alternating voltage V2 from the secondary winding S1 to the first output terminal and an alternating voltage V3 from the secondary winding S2 to the second output terminal. The alternating voltage V3 has an opposite phase with respect to the alternating voltage V2. According to this configuration, the secondary windings S1 and S2 of the transformer Ta only need to generate each a voltage half an inverter output voltage, and therefore, the transformer may have low withstand voltage. The voltage conversion circuit 12a may be made of two transformers that output voltages of opposite phases.

In the discharge lamp lighting apparatus for lighting a discharge lamp, parasitic capacitance generally exists between the discharge lamp and, for example, a casing on which the discharge lamp is mounted, and through the parasitic capacitance, a leakage current passes. If the discharge lamp is long to increase a voltage applied thereto, the leakage current increases and the influence thereof becomes not ignorable. The brightness of a discharge lamp is mainly determined by a current value passing through the discharge lamp. The current of the discharge lamp is the sum of an original discharge current and a leakage current passing through parasitic capacitance.

FIG. 5(b) is a view illustrating a distribution of leakage current in the discharge lamp lighting apparatus illustrated in FIG. 4. In FIG. 5(b), an arrow parallel to parasitic capacitance illustrated with a dotted line indicates a current passing through the parasitic capacitance and the length of the arrow indicates the magnitude of the passing current. An operational ground potential (GND potential) of the discharge lamp is present around the center of the discharge lamp and the magnitude of the leakage current is symmetrical on each side of the center of the discharge lamp.

FIG. 6 illustrates states of current passing through the discharge lamp. In FIG. 6(a), the current flows in one direction, and in FIG. 6(b), in the opposite direction. The leakage current passing from the surface of the discharge lamp through the parasitic capacitance to the GND potential contributes to the brightness of the discharge lamp. In FIG. 6, the number of arrows corresponds to a current amount. A current amount at each end of the discharge lamp is larger than that at around the center thereof. At each end of the discharge lamp, the current amount is the same. Accordingly, the brightness of the discharge lamp is high at each end of the discharge lamp and is low around the center thereof as illustrated in FIG. 5(a). However, the brightness gradient is gentle.

As explained above, the related discharge lamp lighting apparatus illustrated in FIG. 4 has no brightness difference between both ends of the discharge lamp and a little brightness gradient between the center of the discharge lamp and each end thereof, to mostly cause no practical problem. Accordingly, the apparatus is widely used for general purpose.

### DISCLOSURE OF INVENTION

The related discharge lamp lighting apparatus illustrated in FIG. 4, however, needs two ballast capacitors for one discharge lamp. A large liquid crystal television unit, for example, uses many discharge lamps. A liquid crystal television unit using, for example, 20 discharge lamps needs 40 ballast capacitors.

A consideration is made to delete one of the two capacitors connected in series with each discharge lamp of the discharge lamp lighting apparatus illustrated in FIG. 4 and thereby form a discharge lamp lighting apparatus having a configuration illustrated in FIG. 7.

If the number of turns N2 of the secondary winding S1 is equal to the number of turns N3 of the secondary winding S2, the absolute voltage value of the alternating voltage V2 from the secondary winding S1 is equal to the absolute voltage value of the alternating voltage V3 from the secondary winding S2. In this case, ends of the discharge lamps 1a to 1d have different potentials with respect to the ground. Since the ballast capacitors C1 to C4 cause voltage drops, the potential to the ground around electrodes of the discharge lamps 1a to 1d connected to the ballast capacitors C1 to C4 is low and that around the other electrodes is high.

FIG. 8(b) is a view illustrating a distribution of leakage current in the discharge lamp lighting apparatus illustrated in FIG. 7. Due to the potential difference to the ground around the electrodes of the discharge lamps, the amount of leakage current around the electrodes not connected to the ballast capacitors C1 to C4 is larger than that around the other electrodes. FIG. 9 illustrates states of current passing through the discharge lamp in the discharge lamp lighting apparatus illustrated in FIG. 7, in which FIG. 9(a) illustrates a state of passing current in one direction and FIG. 9(b) in the opposite direction. Due to the current value difference between the ends of the discharge lamp, there is a brightness difference between the ends of the discharge lamp as illustrated in FIG. 8(a). Namely, the discharge lamp involves a brightness gradient. The brightness gradient becomes conspicuous as the length of the discharge lamp extends.

Although the discharge lamp lighting apparatus illustrated in FIG. 7 causes brightness gradients on the discharge lamps, it has a merit of reducing the ballast capacitors. Accordingly, the discharge lamp lighting apparatus illustrated in FIG. 7 is appropriate for a case that allows the brightness gradient to some extent. It, however, is inappropriate for a liquid crystal television unit or an illuminating unit that is directly viewed or viewable by persons.

According to the present invention, a discharge lamp lighting apparatus that is inexpensive and is capable of generally relaxing variation of brightness caused by the brightness gradient of a discharge lamp can be provided.

According to a first technical aspect of the present invention, a discharge lamp lighting apparatus includes an inverter to convert a DC voltage into an alternating voltage and outputting the alternating voltage from a first output terminal and second output terminal, a first ballast element whose first terminal is connected to the first output terminal of the inverter, a first discharge lamp connected between a second terminal of the first ballast element and the second output terminal of the inverter, a second ballast element whose first terminal is connected to the second output terminal of the inverter, and a second discharge lamp connected between a second terminal of the second ballast element and the first output terminal of the inverter.

According to a second technical aspect of the present invention, the discharge lamp lighting apparatus is characterized in that a pair of the first ballast element and first discharge lamp comprises a plurality of pairs of ballast elements and corresponding discharge lamps and a pair of the second ballast element and second discharge lamp comprises a plurality of pairs of ballast elements and corresponding discharge lamps.

According to a third technical aspect of the present invention, the first and second ballast elements according to the first technical aspect or the second technical aspect are capacitors.

According to a fourth technical aspect of the present invention, the first and second ballast elements according to the first technical aspect or the second technical aspect are coils.

### BRIEF DESCRIPTION OF DRAWINGS

FIG. 1 is a view illustrating a configuration of an inverter used by a related discharge lamp lighting apparatus.

FIG. 2 is a view illustrating a configuration example of a related discharge lamp lighting apparatus employing ballast capacitors.

FIG. 3 is a view illustrating a configuration example of a related discharge lamp lighting apparatus employing a ballast coil.

FIG. 4 is a view illustrating a configuration of another related discharge lamp lighting apparatus.

FIG. 5 is a view illustrating leakage current and a distribution of brightness in the discharge lamp lighting apparatus illustrated in FIG. 4.

FIG. 6 is a view illustrating a state of current passing to a discharge lamp in the discharge lamp lighting apparatus illustrated in FIG. 4.

FIG. 7 is a view illustrating a configuration formed by partly removing ballast capacitors from the discharge lamp lighting apparatus illustrated in FIG. 4.

FIG. 8 is a view illustrating leakage current and a distribution of brightness in the discharge lamp lighting apparatus illustrated in FIG. 7.

FIG. 9 is a view illustrating a state of current passing to a discharge lamp in the discharge lamp lighting apparatus illustrated in FIG. 7.

FIG. 10 is a view illustrating a configuration of a discharge lamp lighting apparatus according to Embodiment 1 of the present invention.

FIG. 11 is a view illustrating a configuration of a discharge lamp lighting apparatus according to a modification of Embodiment 1 of the present invention.

FIG. 12 is a view illustrating a configuration of a discharge lamp lighting apparatus according to Embodiment 2 of the present invention.

FIG. 13 is a view illustrating a configuration of a surface light source employing the discharge lamp lighting apparatus according to Embodiment 2 of the present invention.

FIG. 14 is a view illustrating a configuration of a discharge lamp lighting apparatus according to Modification 1 of Embodiment 2 of the present invention.

FIG. 15 is a view illustrating a configuration of a surface light source employing the discharge lamp lighting apparatus according to Modification 1 of Embodiment 2 of the present invention.

FIG. 16 is a view illustrating a configuration of a discharge lamp lighting apparatus according to Modification 2 of Embodiment 2 of the present invention.

FIG. 17 is a view illustrating a configuration of a discharge lamp lighting apparatus according to Modification 3 of Embodiment 2 of the present invention.

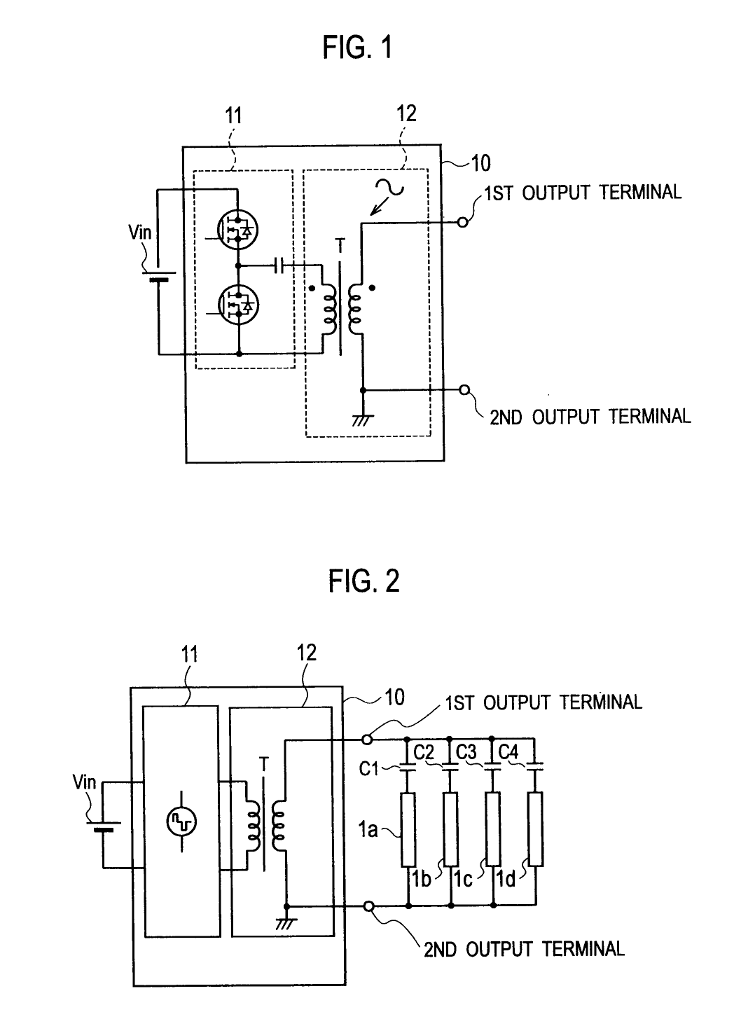

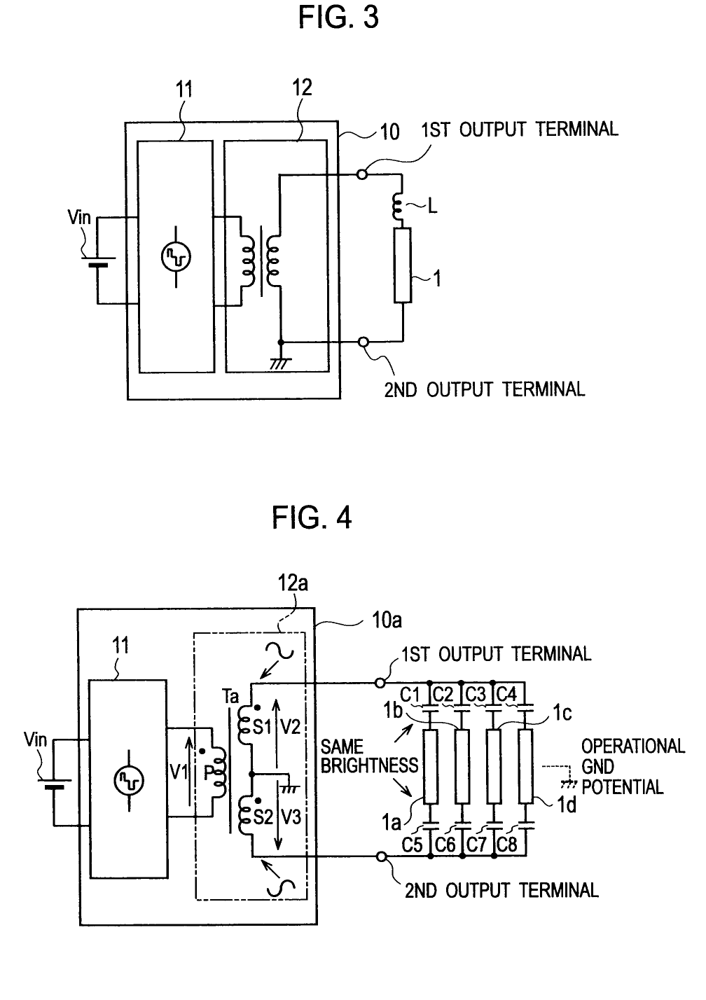

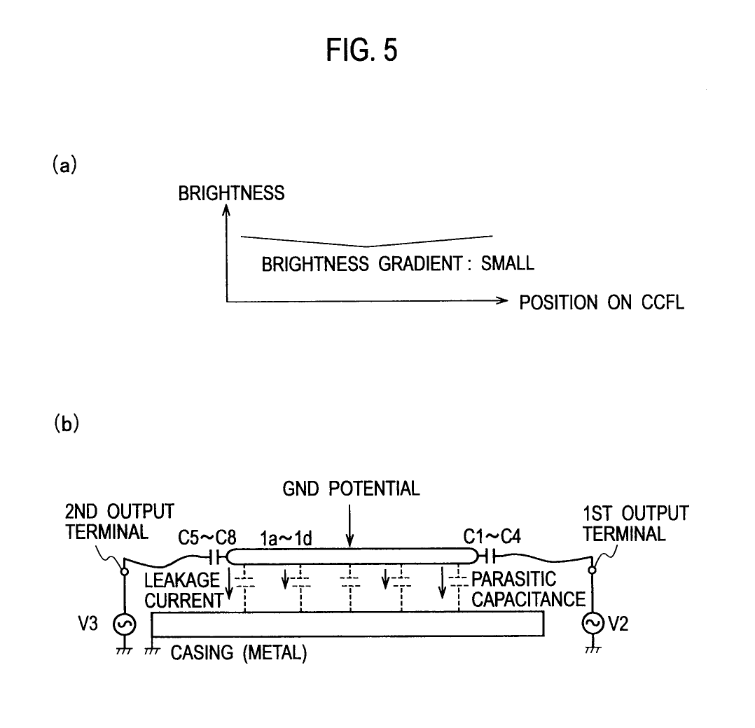

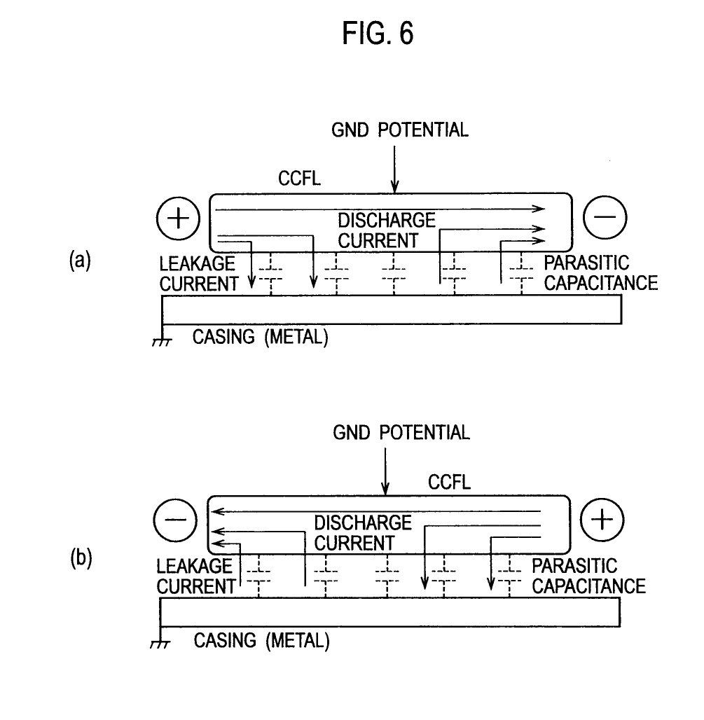

### BEST MODE OF IMPLEMENTING INVENTION

### Embodiment 1

Embodiments of the present invention will be explained in detail with reference to the drawings.

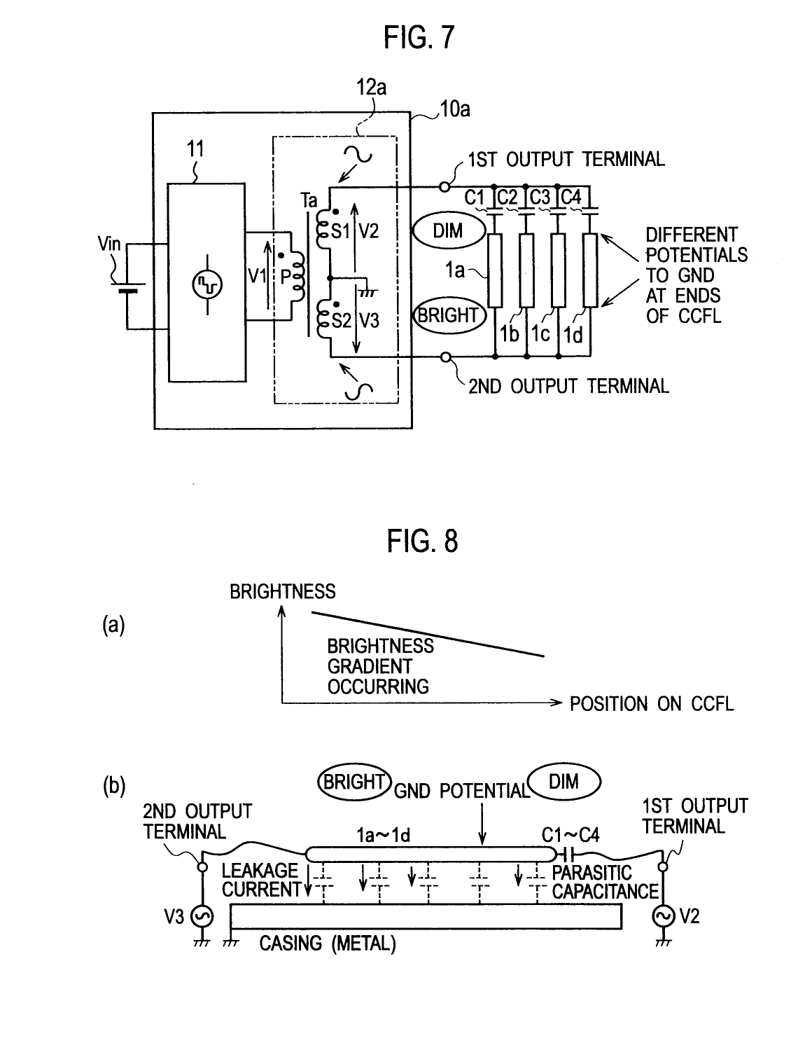

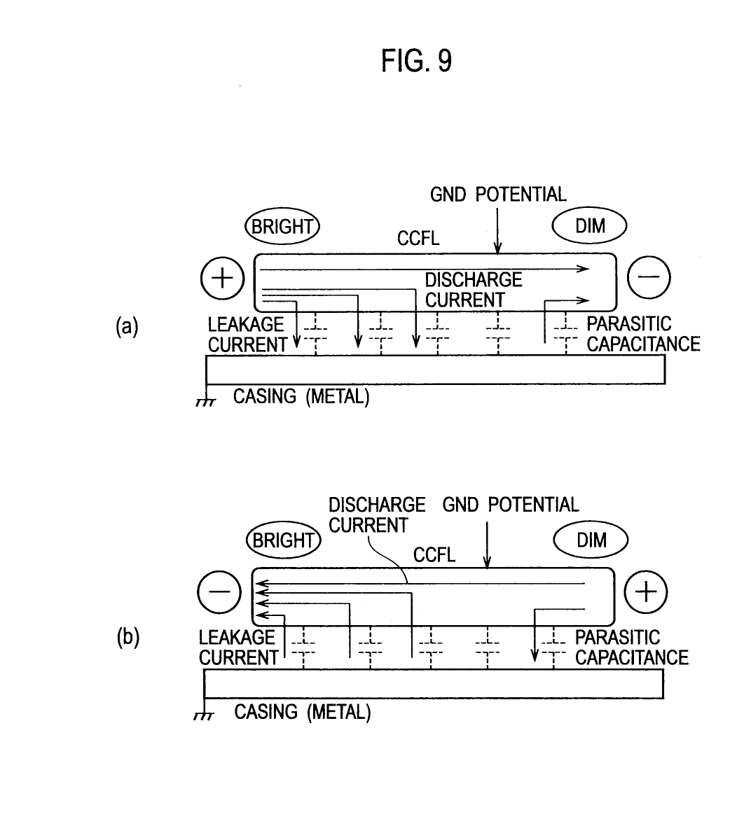

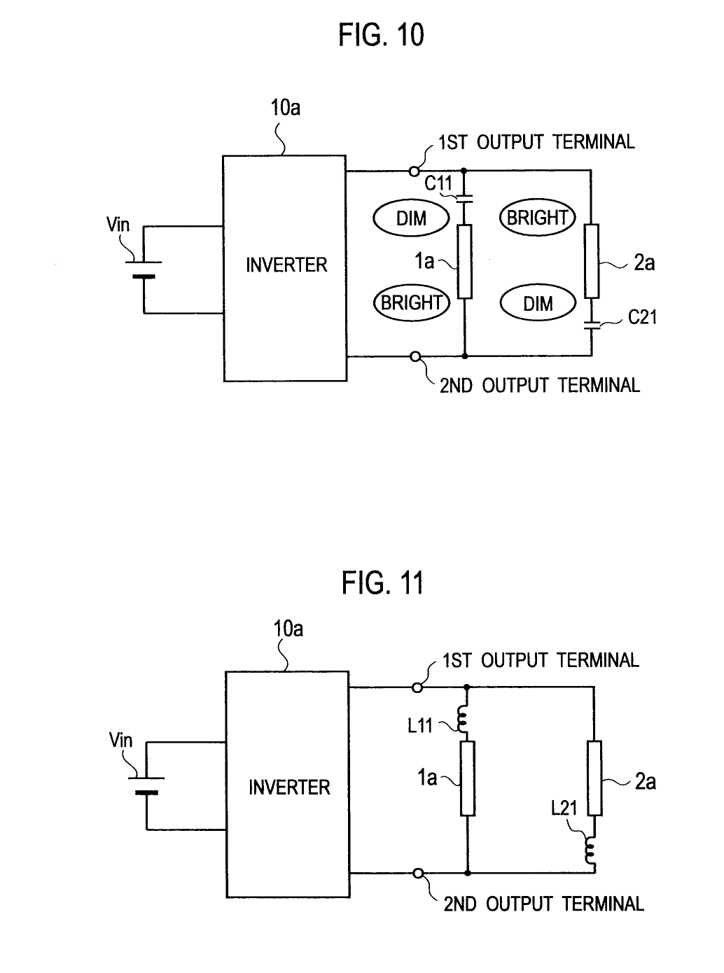

FIG. 10 is a view illustrating a configuration of a discharge lamp lighting apparatus according to Embodiment 1 of the present invention. This discharge lamp lighting apparatus includes a DC power source Vin, an inverter 10a, ballast capacitors C11 and C21, a discharge lamp 1a, and a discharge lamp 2a. The configuration of the inverter 10a of this discharge lamp lighting apparatus is the same as that of the discharge lamp lighting apparatus illustrated in FIG. 7. The ballast capacitor C11 corresponds to the first ballast element of the present invention, the ballast capacitor C21 corresponds to the second ballast element of the present invention, the discharge lamp 1a corresponds to the first discharge lamp of the present invention, and the discharge lamp 2a corresponds to the second discharge lamp of the present invention.

A first terminal of the discharge lamp 1a is connected through the ballast capacitor C11 to a first output terminal of the inverter 10a and a second terminal thereof is connected to a second output terminal of the inverter 10a. A first terminal of the discharge lamp 2a is connected to the first output terminal of the inverter 10a and a second terminal thereof is connected through the ballast capacitor C21 to the second output terminal of the inverter 10a.

In the discharge lamp lighting apparatus according to Embodiment 1, as explained with reference to the discharge lamp lighting apparatus illustrated in FIG. 7, potentials to the ground at ends of the discharge lamps 1a and 2a differ from each other, and therefore, amounts of leakage current at the ends differ from each other. Accordingly, each of the discharge lamps 1a and 2a has brightness gradients.

The discharge lamp 1a is dim at the end connected to the ballast capacitor C11 on the first output terminal side of the inverter 10a and is bright at the end connected to the second output terminal. On the contrary, the discharge lamp 2a is dim at the end connected to the ballast capacitor C21 on the second output terminal side of the inverter 10a and is bright at the end connected to the first output terminal of the inverter 10a. As results, an unevenness in the brightness of the discharge lamp lighting apparatus as a whole is smoothed to be inconspicuous.

As explained above, the discharge lamp lighting apparatus according to Embodiment 1 of the present invention arranges the discharge lamps 1a and 2a in such a way as to reverse tendencies of brightness gradients between them, to thereby compensate the brightness gradients. This relaxes non-uniformity in brightness as a whole and makes it inconspicuous. This embodiment enables a circuit system like the one illustrated in FIG. 7 that causes brightness gradients to be adopted to halve the number of capacitors compared to the related discharge lamp lighting apparatus that arranges ballast capacitors on each side of a discharge lamp.

The discharge lamp lighting apparatus according to the present embodiment employs the ballast capacitors C11 and C21 as the first and second ballast elements, respectively. As illustrated in FIG. 11, the apparatus is modifiable to employ ballast coils L11 and L21 instead of the ballast capacitors C11 and C21. The discharge lamp lighting apparatus according to the modification of Embodiment 1 operates like Embodiment 1 and provides similar effect.

### Embodiment 2

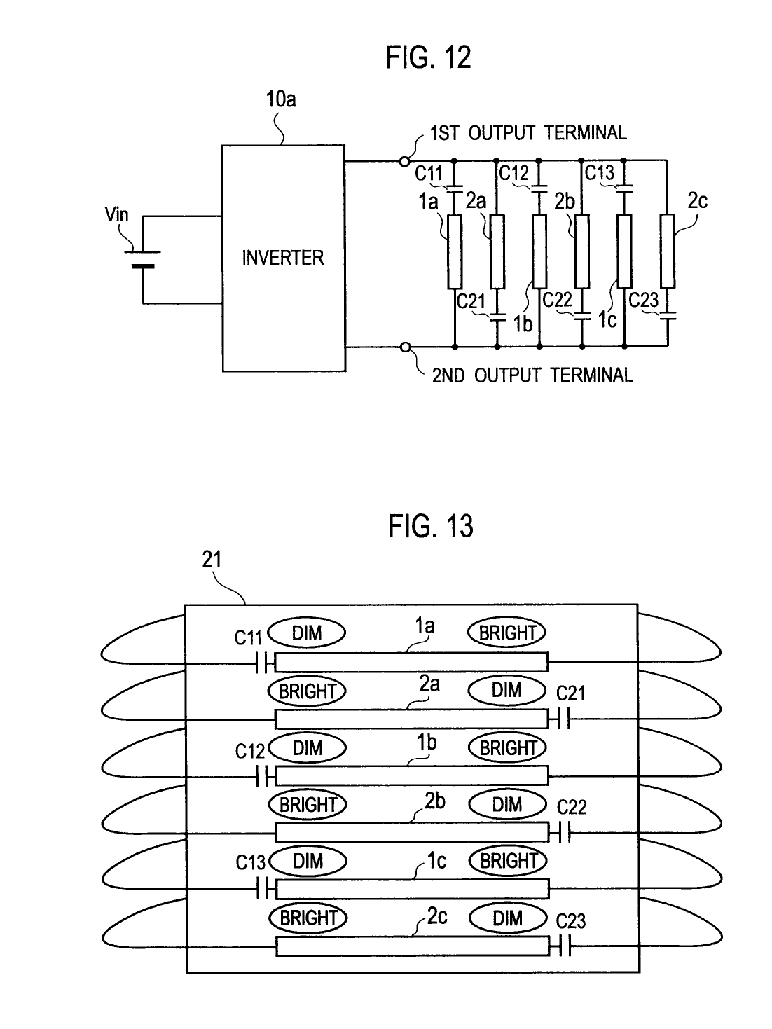

FIG. 12 is a view illustrating a discharge lamp lighting apparatus according to Embodiment 2 of the present invention. This discharge lamp lighting apparatus has a plurality of pairs of the ballast capacitor C11 and discharge lamp 1a of the discharge lamp lighting apparatus of Embodiment 1, and in addition, a plurality of pairs of the ballast capacitor C21 and discharge lamp 2a of Embodiment 1.

More precisely, first terminals of the discharge lamps 1a, 1b, and 1c are connected through the ballast capacitors C11, C12, and C13, respectively, to a first output terminal of an inverter 10a and second terminals of them are connected to a second output terminal of the inverter 10a.

First terminals of the discharge lamps 2a, 2b, and 2c are connected to the first output terminal of the inverter 10a and second terminals thereof are connected through the ballast capacitors C21, C22, and C23, respectively, to the second output terminal of the inverter 10a.

The discharge lamps 1a, 1b, 1c, 2a, 2b, and 2c are arranged so that brightness gradients oppose between adjacent discharge lamps, i.e., electrodes of the discharge lamps to which the ballast capacitors are connected alternate.

The discharge lamp lighting apparatus according to the present embodiment arranges a plurality of discharge lamps so that tendencies of brightness gradients oppose between adjacent discharge lamps. This smoothes variation of brightness as a whole and makes brightness unevenness inconspicuous. This embodiment enables a circuit system like the one illustrated in FIG. 7 that causes brightness gradients to be adopted to halve the number of capacitors compared to the related discharge lamp lighting apparatus that arranges ballast capacitors on each side of a discharge lamp.

When using the discharge lamp lighting apparatus according to the present embodiment for a liquid crystal television backlight, a monitor backlight, or an illuminating panel, a plurality of discharge lamps are arranged so that brightness gradients oppose between adjacent discharge lamps and a panel 21 made of, for example, a diffusing sheet is placed over the discharge lamps to form a surface light source as illustrated in FIG. 13, the surface light source illuminating a surface area with linear light from the discharge lamps. Even if the discharge lamps have different brightness gradients, the panel 21 averages the brightness gradients to form the surface light source having no brightness unevenness.

This embodiment enables a circuit system like the one illustrated in FIG. 7 that causes brightness gradients to be adopted to halve the number of capacitors compared to the related discharge lamp lighting apparatus that arranges ballast capacitors on each side of a discharge lamp. This effect becomes larger as the number of discharge lamps used in the system increases. For example, a system to drive 20 discharge lamps can reduce the number of ballast capacitors to 20 from 40.

Although the above-mentioned discharge lamp lighting apparatus according to Embodiment 2 employs six discharge lamps, the number of discharge lamps employed by the discharge lamp lighting apparatus according to the present invention is optional and is two or more.

### (Modification 1)

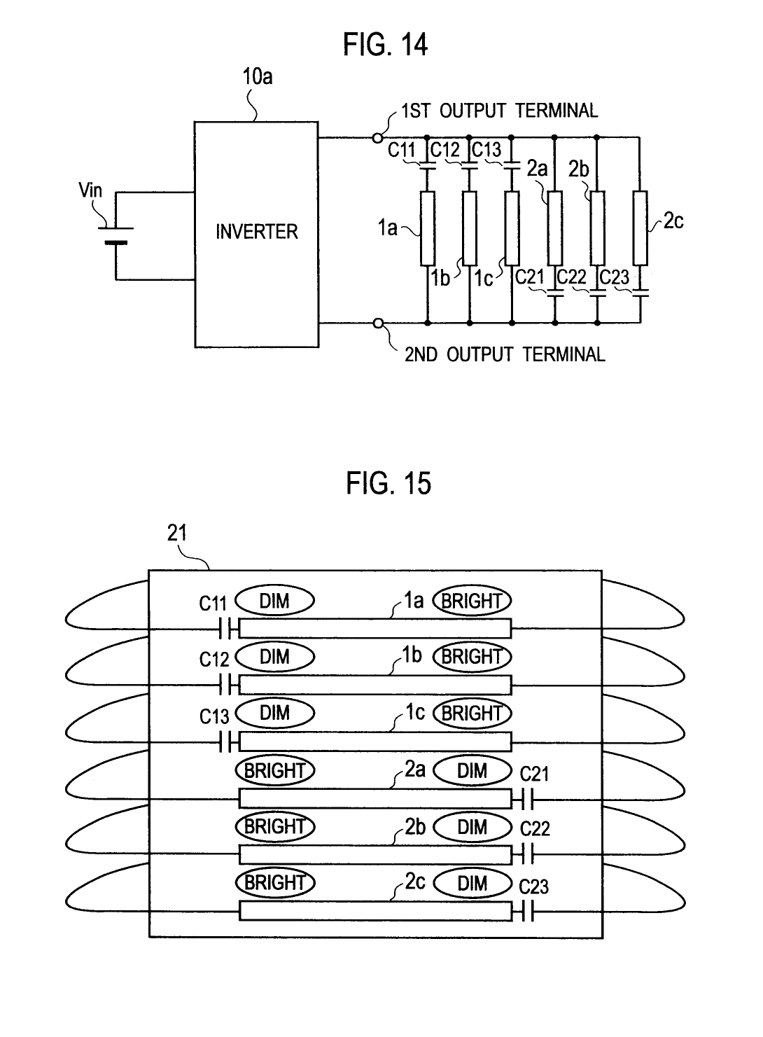

In the discharge lamp lighting apparatus according to Embodiment 2, the discharge lamps 1a, 1b, 1c, 2a, 2b, and 2c are arranged so that tendencies of brightness gradients oppose between adjacent discharge lamps. As illustrated in FIG. 14, the arrangement of discharge lamps is modifiable so that discharge lamps having the same brightness gradient are gathered.

The discharge lamp lighting apparatus of Modification 1 operates like the discharge lamp lighting apparatus of Embodiment 2 and provides similar effect.

When using the discharge lamp lighting apparatus according to Modification 1 for a liquid crystal television backlight, a monitor backlight, or an illuminating panel, a plurality of discharge lamps are arranged so that discharge lamps having the same brightness gradient are collected and a panel 21 made of, for example, a diffusing sheet is placed over the discharge lamps to form a surface light source as illustrated in FIG. 15, the surface light source illuminating a surface area with linear light from the discharge lamps.

### (Modification 2)

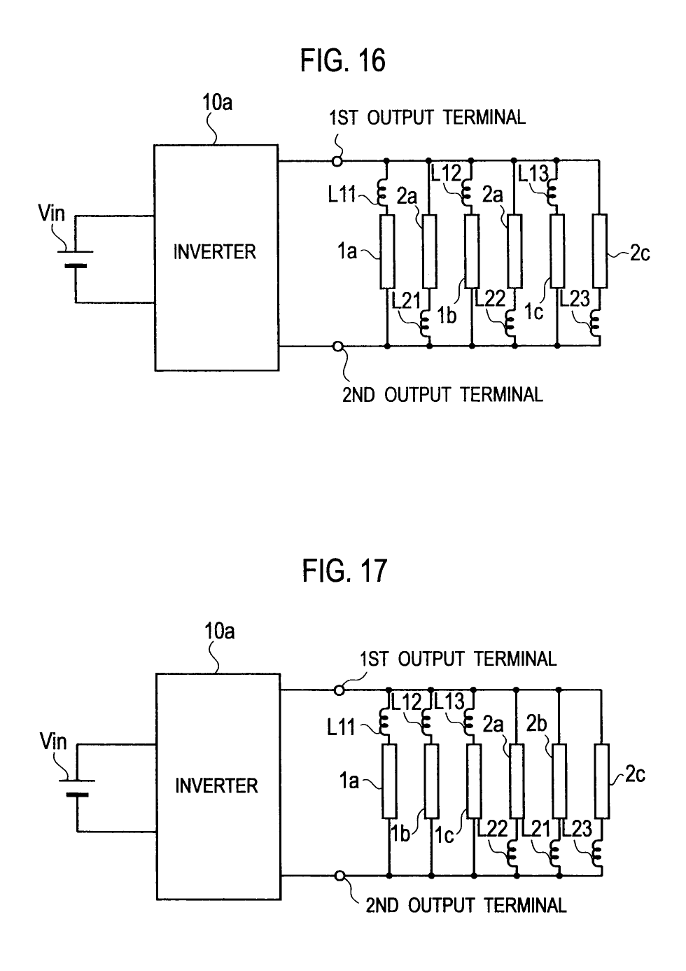

In the discharge lamp lighting apparatus according to Embodiment 2, the ballast capacitors C11 to C13 and C21 to C23 are used as the ballast elements. As illustrated in FIG. 16, the apparatus is modifiable to employ ballast coils L11 to L13 and L21 to L23 instead of the ballast capacitors C11 to C13 and C21 to C23.

The discharge lamp lighting apparatus of Modification 2 operates like Embodiment 2 and provides similar effect.

### (Modification 3)

Although the discharge lamp lighting apparatus according to Modification 1 of Embodiment 2 employs the ballast capacitors C11 to C13 and C21 to C23 as the ballast elements, the apparatus is modifiable as illustrated in FIG. 17 to employ ballast coils L11 to L13 and L21 to L23 instead of the ballast capacitors C11 to C13 and C21 to C23.

The discharge lamp lighting apparatus of Modification 3 operates like Modification 1 of Embodiment 2 and provides similar effect.

Although Embodiment 1 and Embodiment 2 employ the inverter 10a, the inverter is not limited to this. For example, the inverter 10 is employable.

### EFFECT OF INVENTION

According to the first technical aspect of the present invention, the first terminal of the first discharge lamp is connected through the first ballast element to the first output terminal of the inverter and the second terminal thereof is connected to the second output terminal of the inverter. The first terminal of the second discharge lamp is connected to the first output terminal of the inverter and the second terminal thereof is connected through the second ballast element to the second output terminal of the inverter.

This results in reversing brightness gradients between the first and second discharge lamps. This generally relaxes a brightness unevenness caused by the brightness gradients of the discharge lamps. In addition, the number of ballast elements is reduced compared to the related discharge lamp lighting apparatus having ballast elements on each side of a discharge lamp. This reduces the cost of the discharge lamp lighting apparatus.

According to the second technical aspect of the present invention, a plurality of pairs of the first ballast element and first discharge lamp and a plurality of pairs of the second ballast element and second discharge lamp are arranged. This arrangement is usable as a surface light source that generally reduces a brightness unevenness caused by the brightness gradients of discharge lamps.

### (United States Designation)

In connection with United States designation, this international patent application claims the benefit of priority under 35 U.S.C. 119(a) to Japanese Patent Application No. 2007-220071 filed on Aug. 27, 2007 whose disclosed contents are incorporated by reference herein.

1. A discharge lamp lighting apparatus comprising:
an inverter configured to receive a DC voltage, convert the DC voltage into an alternating voltage, and output the alternating voltage from a first output terminal and second output terminal;
a first ballast element whose first terminal is connected to the first output terminal of the inverter;
a first discharge lamp connected between a second terminal of the first ballast element and the second output terminal of the inverter;
a second ballast element whose first terminal is connected to the second output terminal of the inverter; and
a second discharge lamp connected between a second terminal of the second ballast element and the first output terminal of the inverter.

2. The discharge lamp lighting apparatus according to claim 1, wherein
a pair of the first ballast element and first discharge lamp comprises a plurality of pairs of ballast elements and corresponding discharge lamps and
a pair of the second ballast element and second discharge lamp comprises a plurality of pairs of ballast elements and corresponding discharge lamps.

3. The discharge lamp lighting apparatus according to claim 1, wherein the first ballast element and second ballast element are capacitors.

4. The discharge lamp lighting apparatus according to claim 2, wherein the first ballast element and second ballast element are capacitors.

5. The discharge lamp lighting apparatus according to claim 1, wherein the first ballast element and second ballast element are coils.

6. The discharge lamp lighting apparatus according to claim 2, wherein the first ballast element and second ballast element are coils.
